(19) United States
(12) Patent Application Publication
(10) Pub. No.: US 2016/0154552 A1
(43) Pub. Date: Jun. 2, 2016

(54) SMART BOOKS

(71) Applicant: Calay Venture S.à r.I., Bettembourg (LU)

(72) Inventor: Cevat Yerli, Frankfurt am Main (DE)

(21) Appl. No.: 14/557,242

(22) Filed: Dec. 1, 2014

(51) Int. Cl. G06F 3/0483; G09G 5/12; H04L 29/08

(52) U.S. Cl. CPC G06F 3/0483; H04L 67/32; G09G 5/12; G09G 2380/14; G09G 2370/022; G09G 2354/00

(57) ABSTRACT

A smart book or device for displaying electronic content may be interactive and interlinked with a plurality of further smart books or devices via a network. The electronic content includes static content, interactive content, and a state of the interactive content. The device may send the state of the interactive content and receive an update related to the interactive content. A processor of the device may update the state of the interactive content in response to the received update and display at least a part of the electronic content according to the updated state of the interactive content, wherein the received update reflects a persistent environment that is responsive to the sent state of the interactive content and a plurality of other states from other devices for displaying electronic content.

### TECHNICAL FIELD

The present disclosure relates to a device for electronic content and a method for operating a device for electronic content. In at least one aspect, the present disclosure relates to interactive electronic books that may be interlinked with one other via a network.

### BACKGROUND

Electronic distribution of information has become increasingly important with wide availability of portable and mobile devices and with the increasing importance of communication networks. With the widespread use of the Internet, it has become possible to deliver electronic books or eBooks on various electronic devices.

Electronic book reader devices according to the state of the art enable a user to read content of an electronic book on a tablet-like device. An electronic book includes content that may include text, images, and other visual content, which is arranged on a display of the reader in order to closely resemble a real page of a book. eBook reader devices try to provide a similar look and feel as with conventional paper books. A typical eBook reader device is a portable or handheld digital device with a display panel and memory capable of storing several electronic books. A user may utilize buttons or a menu on the reader apparatus to navigate through the electronic book. There are some advantages to using an eBook reader device over conventional paper books. An eBook reader device is typically capable of storing a variety of electronic books and, therefore, weighs significantly less than the same number of paper books. These advantages can in particular be used for travel, educational, and business purposes.

However, eBook readers are typically focused on static content and have only a limited interactivity mainly directed at navigating through the electronic book. Furthermore, eBook readers do not allow users' electronic books to interconnect with one other.

In view of the above, at least one aspect of the present invention is to provide a reader device or a method for operating a reader device with an improved interactivity and connectivity.

### SUMMARY AND INITIAL DESCRIPTION

The present disclosure includes a reader device for electronic content, a method for operating a reader device for electronic content, and a network system, e.g., according to the independent claims that follow the description. Various preferred embodiments are defined in the corresponding dependent claims.

According to the present disclosure, a device for electronic content is provided, comprising a memory configured to store data associated with electronic content, the electronic content including static content, interactive content, and a state of the interactive content, and a display configured to display at least a part of the electronic content. Furthermore, the reader device comprises a network interface configured to send, via a network, a state of the interactive content and receive an update related to the interactive content. The reader device further comprises a processor configured to update the state of the interactive content in response to the received update and to display on the display at least a part of the electronic content according to the updated state of the interactive content. The received update reflects a persistent environment accessible via the network, wherein the persistent environment is responsive to the sent state of the interactive content and a plurality of other states from other devices.

The reader device for electronic content enables an exchange of states related to interactive content of electronic content with a remote persistent environment, which receives states of the interactive content from a plurality of reader devices and, in turn, provides an update related to the plurality of states to each reader device. Hence, the device may represent a printed book that may be turned into an electronic book or ebook, which may be interlinked, via a network, with a plurality of other ebooks. Hence, the devices may provide a shared experience of the electronic content across a community of a plurality of users. For example, users or readers may be connected, via the device, to a massive audience of other readers operating respective devices.

The reader device enables consumption of electronic content, such as various media content, which includes static content and interactive content. The static content may be combined with the interactive content that is displayed according to a current state of the interactive content. Accordingly, the electronic content provides for display of static information and data enhanced with interactive elements that may change over time in response to user interaction, which may be synchronized by the online persistent environment. Based on the received update reflecting a current state of the persistent environment, the reader device will update the local state of the interactive content, which may directly influence the display of the electronic content on the reader device.

Hence, further to a local processing and update of the state of the interactive content, the reader device is responsive to updates reflecting the persistent environment hosted on the network, which reflects a state of the interactive content of the electronic content based on the sent state from the reader device and a plurality of other states provided by other devices, such as other reader devices directed to at least the same interactive content. Hence, the consumption of the interactive content is interlinked with interactive content presented on other devices and respective updates of states from the other devices, and, therefore, allows for a shared experience between users of the different reader devices.

Accordingly, the reader device according to the present disclosure is highly flexible in displaying various electronic content, such as classic electronic books or media with static content, interactive electronic books or media further including interactive elements or interactive pages, and, in contrast to static online content such as web pages, even massively interactive and interconnected electronic content, providing for a shared experience of the electronic content between a plurality of users that is mediated by the persistent environment.

In one embodiment, the persistent environment is hosted on a server linking a plurality of devices for electronic content. The device may represent a new form of a book, where users may interact with a part of the electronic content and may be provided with feedback from the community of other readers, such as information about a number of readers interacting with this part of the electronic content. Similarly, by clicking on a part of the electronic content, interactive content may be executed, for example, to play a mini-game, watch a video clip, make a comment, and others. Since these interactions are shared with the community of other users and/or readers, massively multiplayer online (MMO) logic may be applied to an electronic book.

Each of the plurality of devices for electronic content may be a device according to an embodiment of the present disclosure. Each of the users or readers may contribute to the state of the persistent environment hosted on the server by interacting with the local device and the respective electronic content. Hence, the plurality of users or readers, who may read the same electronic content having at least partially the same static content and/or interactive content (however, a different state of the interactive content), may contribute to the persistent environment on the server. Therefore, the community of the plurality of readers may drive the electronic content in terms of what the readers do, how they interact with individual parts of the electronic content, such as pages, or even with each other, and/or how many of them are at a particular section or part of the electronic content. The electronic content could comprise interactive parts, such as pages. If a number of users reading a part or a particular section of the part exceeds a threshold, an activity or behavior of the persistent environment could be triggered, such as delivering further media content, providing for interactive activities between the readers and others. Accordingly, users or readers may have a direct impact on what the server delivers via the persistent environment based on local interaction with the device.

The persistent environment may be persistently maintained on the server and accessed via the network by the plurality of devices. The persistent environment may represent the state of the interactive content of the electronic content of the plurality of devices as well as the input or a processed input received from the plurality of devices, which may be fed into the persistent environment. The persistent environment may also be adjusted based on interactions and other parameters from the plurality of devices and respective computations may depend on the received parameters, interactions, states, and/or data in order to influence the persistent environment and a respective delivered output.

According to a preferred embodiment, the device further comprises an input controller configured to detect an input of the user. Preferably, the detected input is provided to the processor. The device may be a reader device or at least a part of an electronic book, a portable device or a mobile device, which may include a display panel, such as a LED panel or an OLED panel, which may further comprise means for detecting tactile feedback, such as using a touch panel. Hence, the device may resemble a printed book turned into an interactive and online electronic book. Any other kind of input, for example using buttons, switches, a pen or a stylus, sensors detecting expressions, movements and/or gestures of a user of the device, and similar input means can be used in order to enable suitable feedback by a user on the electronic content. Hence, the device provides for embedded interaction within parts of electronic content, such as pages of an electronic book that can be shared with other users via the network using the persistent environment or a corresponding MMO component. The processor may either receive and further process the input of the user or may directly send the detected input together with the state of the interactive content via the network.

Preferably, the device may further comprise a plurality of displays, each configured to display at least a part of the electronic content. The device may represent an electronic book, which may feel like a traditional book, including a plurality of pages of a book. One or more of the displays may display the electronic content including static content and interactive content according to the state of the interactive content. The displays may be flexible displays, such as comprising flexible OLED panels or other forms of flexible electronic paper displays.

According to at least one embodiment, responsive to the detected input, the processor is configured to update the state of the interactive content based on the detected input and to send, via the network interface, the updated state. Hence, the processor may be configured to process the detected input in order to determine a next state of the interactive content and may temporarily update the state prior to sending the updated state via the network. The processor may continue with the display of the electronic content based on the temporarily updated state and need not wait for a response, including the update reflecting the persistent environment. This allows for a seamless display of electronic content on the reader device without a perceivable latency. As soon as the update reflecting the persistent environment is received, the processor may analyze the received update, again update the temporarily updated state of the interactive content, and reiterate the display of the electronic content to reflect the persistent environment.

In yet another embodiment, responsive to the detected input, the processor is configured to send, via the network interface, the detected input and the current state of the interactive content. Hence, the processor may be a dedicated processor and need not process the received input. Rather, the detected input may be directly provided together with a current state of the interactive content via the network without any further processing or update and the current state of the interactive content is updated as soon as the response including the update reflecting the persistent environment is received. This allows for limited resources in the reader device and lower costs of the hardware, such as in a thin client, while enabling a consistent update according to a persistent environment.

According to yet another embodiment, the displayed part of the electronic content includes at least a part of the static content in combination with at least a part of the interactive content according to a current state of the interactive content. Preferably, the interactive content includes interactive elements enabling an interactive experience with the content. The interactive elements may include buttons, menu items, images, icons, and the like, which may be arranged in combination with the static content and coupled to parts of the static content, such that as soon as a user interacts with one of the interactive elements, the interaction may trigger an update of the state of the interactive element leading, for example, to a modified selection of the static content to be displayed on the display. For example, an interactive element may be used by the user to select a particular part of the static content for display. Likewise, an interactive element may be triggered by the user to select an alternative of the static content, such as a course or development of a storyline, presentation, or any other branch or sector of the static content.

In a preferred embodiment, the interactive content and the state are dynamically updated via the network based on the persistent environment. Accordingly, the processing on the server may be dynamic, such that the persistent environment and the respective electronic content or state of the electronic content may change according to how readers or users are interacting with the electronic content on the individual devices.

Additionally, or as an alternative, according to yet another embodiment, the interactive content includes embedded elements enabling a shared experience of the static content based on the persistent environment. The embedded elements may be arranged in combination with the static content and/or the interactive elements of the interactive content and may directly reflect a state of the persistent environment, which is based on updates from various other devices, including other reader devices. Hence, the embedded elements provide for a shared experience of the electronic content with other users of other electronic devices. According to at least one example, the embedded elements may provide for an overview of a current state of the electronic content on other devices, such as a particular section of the electronic content, for example, a chapter of an electronic book, that is currently perceived by another user. The embedded elements may, however, also represent a virtual world represented by the persistent environment, which is continuously updated by users operating reader devices to reflect a jointly controlled virtual world, such as an online game or an online consumption of content that may be collaboratively and conjointly perceived and controlled by the users of the reader devices.

According to a preferred embodiment, the processor is further configured to execute at least a part of the interactive content. For example, the interactive content, including the embedded elements and the interactive elements, may further include executable code that can be executed by the processor. The executable code may be processed in response to an interaction of the user with an interactive element or an embedded element and may directly influence the static content, the interactive content, the state of the interactive content, as well as parts thereof or a combination thereof. The executable code may also be configured to wait for a response related to the state of the persistent environment to modify the static content, the interactive content, the state of the interactive content, as well as parts thereof or combinations thereof. This allows for an improved flexibility of the interactive content.

In yet another embodiment, the device is an electronic book reader device and the electronic content is an electronic book. For example, the static content may relate to the data representing the content of a book, such as text, illustrations, graphics, and other parts of a static book that may be arranged in sections and/or on pages according to a particular layout. Furthermore, the interactive elements may be configured to interactively modify and update the static content to provide for an interactive and shared experience of the static content. Hence, according to the present disclosure, existing static content can be further enhanced with interactive elements in order to provide for an interactive and shared experience of the static content. Furthermore, legacy eBook reader hardware can also be enhanced by incorporating a network interface and by providing respective processing resources to interactively affect the static content using the interactive content and the state of the interactive content based on updates reflecting the persistent environment. Preferably, the static content includes one or more pages of a book and the interactive content includes interactive elements and embedded elements modifying the pages of the book based on the persistent environment.

In yet another embodiment, the persistent environment reflects a persistent world of a massively multiplayer online game. Accordingly, the reader device may provide for an enhanced experience of static content closely interconnected with interactive content linked to a large amount of interconnected players or gamers playing an online game.

In yet another embodiment, the received update includes media rendered by a game engine hosted on the network. Further to a processor and other local rendering capabilities on the reader device, several processing tasks can be performed or hosted on the network, such as using one or more online processing devices or server devices, including one or more processors processing the input data to affect the interactive elements or the state of the interactive content, executing parts of the interactive content online, and generating rendered output online, wherein the generated results, such as the rendered output, may be directly provided to the reader device and directly displayed thereon without requiring further processing or rendering on the device. Preferably, these tasks may be performed by a game engine.

A game engine, as used throughout this description, may represent a software layer designed for creation and development of games, wherein developers may use the game engine to develop games independent of the target platform or a reader device and in an abstract form, which need not include implementation of technical details, for example related to rendering, physics, animation, scripting, and others. Hence, the game engine may include one or more of a rendering engine for 2D or 3D graphics, a physics engine, collision detection, collision response, sound, scripting, animation, artificial intelligence, networking, streaming, memory management, threading, localization support, and the like. Furthermore, the game engine may represent a world or environment of the game using a scene graph and other data to describe the interactivity.

Preferably, the game engine may include a real-time graphics or rendering engine configured to generate a rendered output responsive to at least one application. A rendering engine, as used throughout this description, may be a software and/or hardware framework capable of receiving an abstract representation of a scene, such as a scene graph, including graphic elements, acoustic elements, and elements of any other modality, as well as definitions of conditions in the scene, such as light conditions. The rendering engine may be capable of processing the information and delivering a highly realistic representation of the scene, including a highly realistic graphic visualization. The rendering engine may utilize dedicated rendering hardware capable of computing a realistic appearance of the elements or individual objects taking into account surface characteristics, reflections, multiple light sources, ambient light, and other conditions. Preferably, the rendering engine is independent of any application or processing task and may process rendering requests from different applications. The rendering engine may be provided as hardware, software, or a combination thereof. For example, the rendering engine may be implemented on a dedicated resource on the network. The rendering engine may be the Cryengine available from Crytek GmbH, Frankfurt am Main, Germany.

The rendering engine may be configured to provide a rending quality that is comparable to a best-looking, animated, photorealistic graphics available for real-time rendering for any application, such as games, business, television applications, and others. Hence, the generated rendered output may be completely independent of the available resources on the reader device as long as the reader device is capable of displaying the rendered output provided to the reader device as a respective update of the state of the interactive content.

Preferably, the rendered output may include a rendered video stream reflecting the output of the application based on the persistent environment. The application may continuously provide its output to the rendering engine responsive to a current state of the persistent environment comprising any input of the users or updates of the states received from the reader devices. The rendering engine may immediately render the data, i.e., only within a short or almost unnoticeable period of time, such as less than 100 ms, preferably less than 50 ms, and most preferably less than 10 ms, and may transmit the rendered output via the network to the reader devices. Hence, the rendered video stream corresponds to an output of the application executed on the network that would be normally displayed on the local reader device. Hence, except for the latency of transmission or a possible compression of the video stream, the video stream cannot be distinguished from a local output. Preferably, the rendered video stream may be variably encoded based on an available bandwidth of the network connection. The rendered video stream can be embedded in an embedded element of the interactive content and displayed as part of the electronic content on the reader device.

According to another aspect, a network system is provided, comprising a plurality of reader devices for displaying electronic content, and one or more server devices maintaining a persistent environment, the persistent environment representing one or more electronic contents, each including static content, interactive content, and one or more states of the interactive content. The one or more server devices are configured to receive from a reader device, via the network, a reader state of an interactive content of an electronic content, to modify at least one of the states of the interactive content responsive to the reader state, and to send an update related to the interactive content based on the modified state of the interactive content. The persistent environment is responsive to reader states received from the plurality of reader devices.

The one or more server devices may be organized or set up as a cluster that may be controlled by a master server. The cluster may consist of a set of loosely connected or tightly connected computing devices that work together so that they can be viewed as a single system providing the access to and maintaining the persistent environment. The components of the cluster may be connected to each other through a fast local area network, wherein each node of the network may correspond to a computing device. A cluster may also be set up as a grid or cloud that is controlled by the master server in order to provide access to the persistent environment.

The one or more server devices or a dedicated one of the server devices may be configured to accept connection requests from individual reader devices in order to provide access to the persistent environment.

According to at least one embodiment, the one or more server devices are further configured to associate a reader device with one or more of the electronic contents. For example, a reader device may connect to one of the server devices and may request a simultaneous experience of an electronic content. The electronic content may be already installed on the reader device or may be provided by the server device via the network and stored on the reader device. For example, the server device may identify the requested electronic content and may query a database to retrieve the electronic content including static content and interactive content, initialize a state of the interactive content, and may provide the electronic content to a reader device. The server device may also check permissions of the reader device to access the electronic content and may start one or more of an identification, authorization, authentication, or purchase process in order to evaluate the permissions of the reader device and/or authorize the reader device to access the electronic content. After an initial access and identification, the server device may associate the reader device with the electronic content and may start receiving reader states from the reader device directed at interactions with interactive content of the electronic content associated with the reader device. Hence, a particular electronic content may define a state of the interactive content of the electronic content which is valid for all associated reader devices.

According to a further embodiment, the one or more server devices are further configured to associate groups of reader devices associated with an electronic content with one of the one or more states of the interactive content of the electronic content. Hence, the one or more server devices may maintain various states of the interactive content of the electronic content valid for different groups of reader devices, thereby enabling different groups of reader devices to perceive a different state of the electronic content. For example, a first group of reader devices which may be operated by a group of users that characterize each other as friends, may simultaneously experience the electronic content according to a first state and/or another group of reader devices operated by another group of users having the same or another affiliation may experience the same electronic content, however, according to another state of the interactive content of the electronic content maintained by the persistent environment. The network system may be configured to synchronize the states of the interactive content of the electronic content according to a set of rules. The network system may also persistently maintain the plurality of states of the interactive content for individual groups.

According to another embodiment, the one or more server devices are further configured to evaluate the reader states received within a predetermined period of time from a group of reader devices associated with a particular state of a particular electronic content and to update the particular state of the particular electronic content based on the evaluated reader states. This enables a use of various techniques for evaluation of input from several players or a large amount of players to, for example, allow for majority voting and other collaborative techniques to control a state of interactive content of electronic content. For example, a group of users may collectively and simultaneously enjoy electronic content and may use the interactive part of the electronic content to submit a vote on a desired progress of the electronic content. Accordingly, the network system may collect and evaluate the individual votes of the group in order to determine a new or updated state of the associated electronic content. Likewise, the network system may receive the individual states from the reader devices, which may be directed at different interactive content, that, however, in combination, form the resulting state of interactive content to be displayed on the individual reader devices. For example, a first user may influence a first character of the electronic content and a second user may influence a second character of the electronic content, wherein both characters are updated within the persistent environment and wherein the results including both characters are provided to both reader devices and other associated reader devices for display. The predetermined period of time may be any time period, for instance in the range of milliseconds, seconds, minutes, or even hours in order to reflect a suitable time period for the desired collaborative technique. For example, real-time updates of individual interactive elements, such as characters, may be performed in the range of milliseconds, such as 100 ms, and majority voting may be set up to generate results in the range of minutes or hours.

According to a preferred embodiment, the network system further comprises a database engine maintaining data on the connected reader devices and the persistent environment. The database engine may be capable of maintaining large amounts of data for the persistent environment including a large amount of electronic content and may further efficiently handle a large amount of reader devices, such as thousands or even millions of users. Based on the amount of users, the network system may also include several database engines, server devices, and individual databases, and may provide for balance loading in order to simultaneously serve the individual reader devices and respective users.

According to another embodiment, the one or more server devices host a game engine configured to execute one or more game applications, each associated with at least one of the electronic contents, and to render output of the one or more game applications to be sent to the reader devices as the update related to the interactive content.

In a preferred embodiment, the one or more server devices host an online service, such as a social network, that provides access to the persistent environment and manages the readers or users of individual devices. The readers or users can be anonymous or logged into the online service or social network to access the persistent environment via their respective devices.

According to another aspect, a method for controlling a reader device for electronic content is provided, the reader device comprising a display for displaying electronic content, the electronic content including static content, interactive content, and a state of the interactive content. The method comprises displaying to a user, via the display, at least a part of the electronic content; sending, via a network, a state of the interactive content indicative of an interaction with the displayed electronic content; receiving, via the network, an update related to the interactive content; and modifying the state of the interactive content in response to the received update. Based on the updated state of the interactive content, at least a part of the electronic content is displayed to the user via the display. The received update reflects a persistent environment accessible via the network, wherein the persistent environment is responsive to the sent state of the interactive content and a plurality of other states from other devices.

The method can be a computer-implemented method that can be implemented or embodied as software modules that are to be executed on processing components of the reader device, such as on a dedicated reader device or on a portable electronic device, such as a tablet or smart phone, for example, an iPad provided by Apple Inc. or a Galaxy Tab provided by Samsung. The method may configure the reader device to provide online, connected and/or massively multiplayer online (MMO) electronic content, preferably book content, according to embodiments of the present disclosure.

According to one embodiment, the method further comprises receiving from the user, via the reader device, an indication of an interaction with the displayed electronic content.

According to a further aspect, one or more computer-readable media are provided, such as non-tangible computer-readable media, said computer-readable media having instructions stored thereon, wherein said instructions, in response to being executed by a computing device, cause said computing device to automatically perform a method according to embodiments of the present disclosure. Preferably, the computing device may be a reader device for electronic content, such as a portable or mobile electronic device or a dedicated reader device. In particular, a reader device for electronic content according to embodiments of the present disclosure may be connected or may comprise the one or more computer-readable media, access the one or more computer-readable media in order to load and install said instructions, and execute respective instructions to perform the method. Hence, the computing device may be configured as a reader device for electronic content, the reader device comprising a display for displaying electronic content, the electronic content including static content, interactive content, and a state of the interactive content, and the computing device may be configured to display to a user, via the display, at least a part of the electronic content; send, via a network, a state of the interactive content indicative of an interaction with the displayed electronic content; receive, via the network, an update related to the interactive content; modify the state of the interactive content in response to the received update; and display to the user, via the display, at least a part of the electronic content based on the updated state of the interactive content, wherein the received update reflects a persistent environment accessible via the network, wherein the persistent environment is responsive to the sent state of the interactive content and a plurality of other states from other devices.

The reader device, the network system, and the method according to embodiments may be configured to include any features of the reader device, the network system, and/or the method according to embodiments of the present disclosure in any combination. In particular, the reader device and the network system may be configured to perform processing steps of one or more methods according to embodiments of the present disclosure. Likewise, the method according to embodiments of the present disclosure may include functionality directed at structural features of the reader device and the network system according to further embodiments of the present disclosure.

The disclosure provides a reader device, and a method for controlling a reader device, and a network system allowing for a highly interactive perception and consumption of electronic content and a simultaneous and shared experience of electronic content mediated via a persistent environment.

### DESCRIPTION OF THE DRAWINGS

The specific features, aspects and advantages of the present disclosure will be better understood with regard to the following description and accompanying drawings where:

FIG. 1 shows a schematic illustration of an electronic reader displaying electronic content according to one embodiment of the present disclosure;

FIG. 2 shows a schematic diagram of a network system and of an electronic reader according to one embodiment of the present disclosure; and

FIG. 3 shows a flow chart of a method according to one embodiment of the present disclosure.

### DETAILED DESCRIPTION

In the following description, reference is made to drawings which show by way of illustration various embodiments. Also, various embodiments will be described below by referring to several examples. It is to be understood that the embodiments may include changes in design and structure without departing from the scope of the claimed subject matter.

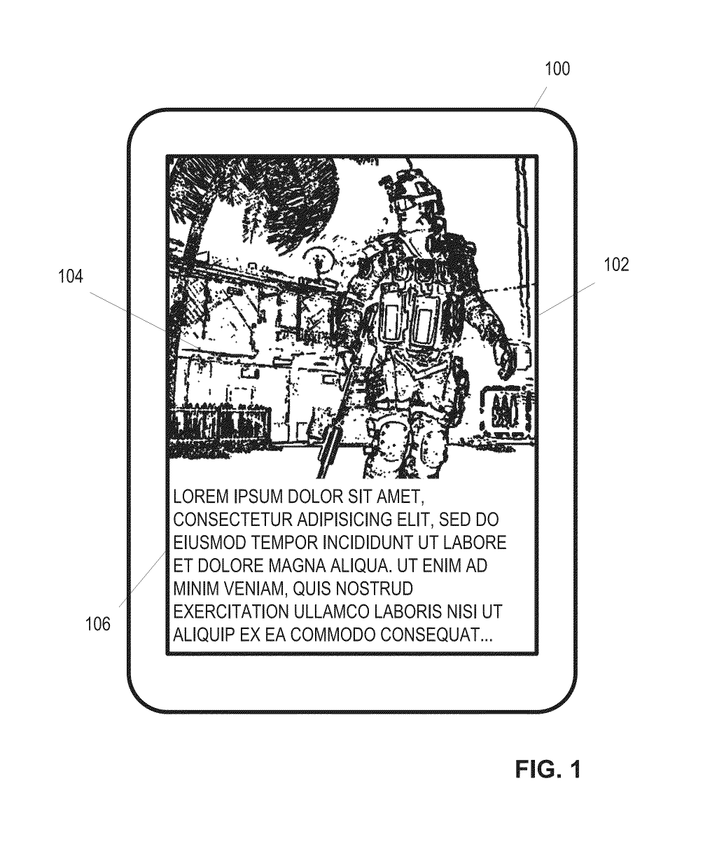

FIG. 1 shows a schematic illustration of a reader device displaying electronic content according to at least one embodiment of the present disclosure. The reader device 100 may include a display portion 102 configured to display various electronic content. The electronic content may include an interactive content 104 and a static content 106. Even though FIG. 1 shows a particular example of electronic content, it is to be understood that other electronic content and representations of electronic content can be used and that the electronic content including the interactive content 104 and static content 106 may be arranged according to any suitable layout or pattern.

The display portion 102 of the reader device 100 may be a touch-sensitive display such that a user may directly touch on a part of the interactive content 104 or the static content 106 in order to provide input that may influence the further representation of the interactive content 104 and the static content 106. The reader device 100 may receive the input and may either process the user input or directly provide the user input via a network to one or more remote servers (not shown) to process the user input. Furthermore, either locally or remotely on the remote servers, a state of the interactive content 104 may be updated, which may lead to a modification of either the interactive content 104, or the static content 106 or both. The modified state of a current state may also be sent to the remote servers.

Based on a response from the remote servers, the state of the interactive content 104 may further be updated, resulting in a modification of either the interactive content 104 or the static content 106 or both.

The reader device 100 may be embodied as an electronic book reader device and may provide for a “smart” functionality. Hence, the reader device 100 may also be referred to as a “smart book.” A smart book may be a digital book enabling a simultaneous and shared experience of electronic content with other users, thereby embodying aspects of a massively multiplayer on-line game (MMO). Accordingly, the reader device 100 may embody MMO logic and may apply the MMO logic to existing electronic books. This allows for an improved interaction with and a better experience of the book, such as watching a video clip, playing a game, making a comment, or experiencing interactive pages in combination with the static content 106 of the book. For example, the user may be prompted to do something, such as saying something or providing another input, which may be further provided to other users interconnected via the persistent environment. Hence, the reader device 100 provides for interaction within sections of electronic content, such as pages of an electronic book or other media content that can be shared with many other users.

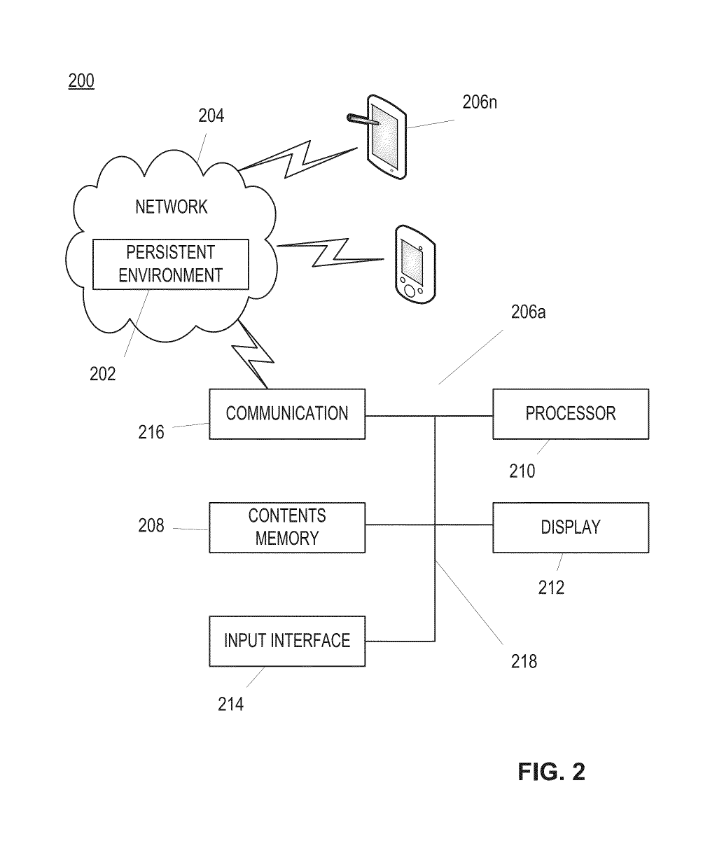

FIG. 2 shows an abstract representation of a network system and of parts of a reader device according to embodiments of the present disclosure. The network system 200 may host a persistent environment 202 on a network 204, which may represent one or more electronic contents, each including static content, interactive content, and one or more states of the interactive content. The network system 200 may accept connections from one or more reader devices 206a, . . . , 206n. As shown, the reader devices 206, . . . , 206n may have various forms, such as tablet-like portable and mobile devices including various types of input means for receiving user input, such as tactile feedback, speech input and video input, as well as output means for rendering the electronic content in various modalities, such as optical data, acoustics, haptics, and other modalities.

The reader devices 206a, . . . , 206n may include a contents memory 208, which may store the electronic content including static content, interactive content, and a state of the interactive content. The contents memory 208 may have a size sufficient to store a plurality of interactive content. The reader devices 206a, . . . , 206n may be also configured to process one or more components of electronic content at a time. The reader device 206 may further comprise a processor 210, a display 212, an input interface 214, and a communication interface 216. The device components 208, . . . , 216 may be interconnected via a bus 218 or using any direct or indirect electronic connection. For example, the processor 210 may access the contents memory 208 to retrieve the electronic content to process the electronic content according to the state of the interactive content and to display at least parts of the electronic content on the display 212. Furthermore, the processor 210 may receive via the bus 218 or the electronic connection input data from the input interface 214. The processor 210 may either directly provide the input via the communication interface 216 to the network 204 together with current state of the electronic content, or may process the input, update the current state of the interactive content, and provide the updated current state of the interactive content via the communication interface 216 to the network 204. The communication interface 216 may be further configured to receive a response from the network system 200 reflecting a current state of the persistent environment 202, which is responsive to the input and/or states received from other reader devices 206a, . . . , 206n.

The communication interface 216 can be any kind of wired or wireless communication interface, such as providing a WiFi or a mobile data connection.

The electronic content including the static content and the interactive content and the state of the interactive content may be represented using a mark-up language, such as HTML or XML, and/or respective scripts. Additionally, or as an alternative, the interactive content may be represented as executable code or as an intermediate code which is to be interpreted on the reader device or on a server device of the network system.

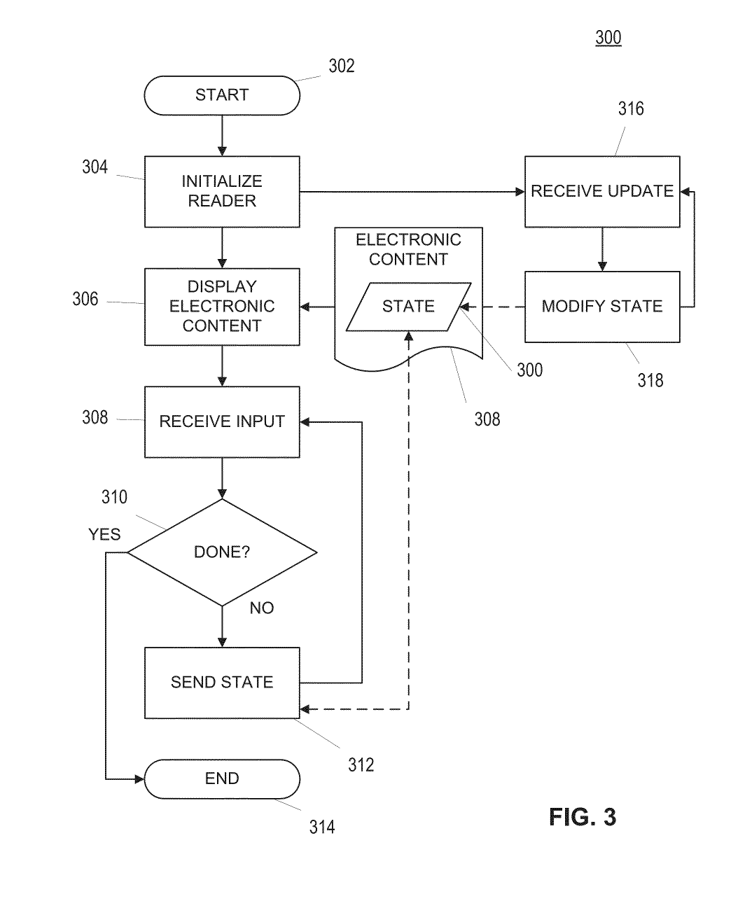

FIG. 3 shows a method according to one embodiment according to the present disclosure. The method 300 begins at block 302 and proceeds with block 304, wherein a reader is initialized for display of electronic content comprising static content, interactive content, and a state of the interactive content. The reader may be loaded with a particular electronic content and an initial connection may be established with a server via a network.

It is to be understood that even though the reader preferably directly connects to a server, the reader may as well be operated in an offline mode, wherein the electronic content may still be interactively perceived on the reader, however, without a direct interaction with the server, thereby only allowing for a local update of the state of the interactive content. In offline mode, the reader may be configured to temporarily store any updates of the state of the interactive content, which may be provided to the server as soon as a connection is available.

The method 300 may proceed with block 306, wherein the electronic content on the reader device may be displayed. The displayed electronic content may include at least parts of a static content in combination with at least parts of an interactive content according to a current state of the interactive content 308. In both offline and online mode, the method 300 may proceed with block 308 and may wait for input of the user. The input may be analyzed to determine 310 if the user would like to end interaction with the reader, which may, for example, be achieved by pushing an on/off button or switch on the device or by providing other respective input.

In case of other input directed at interaction with electronic content 308, the method 300 may proceed with block 312. In online mode, the reader may send the current state and/or the input of the user to the server. In both offline and online mode, the reader may use the input to modify the state 310 of the electronic content 308. This step may be optional, as indicated by the dashed line between blocks 312 and 310. The method may proceed with block 308 and reiterate the processing.

If the user indicates that he intends to end the interaction with the reader, the method 300 ends in block 314.

In online mode or as soon as a connection with the server is available, the method 300 may wait for updates received from the server in block 316. As soon as an update is received, the state 310 of the electronic content 308 can be modified in block 318 and the method 300 may continue to receive further updates in block 316.

The processing in blocks 316 and 318 can be implemented in a separate loop, which may be executed in parallel to blocks 304 to 312. Furthermore, any further processing steps can be implemented in parallel. For example, the display of electronic content in block 306 may be independent of the processing in blocks 308 to 312 related to user input and may be implemented in parallel. However, it is to be understood that the method 300 may be implemented in a sequential order wherein the loops 308 to 312 and 316 to 318 may be interleaved to provide the respective functionality directed at user input and response from the server.

The claimed subject matter, in particular the method, the workflow of the network system, as well as respective applications and the game engine and/or rendering engine, may be implemented using object-oriented programming techniques. For example, each component or interface of the reader device 100 or of the network system 200 and each processing step of the method 300 according to embodiments of the present disclosure can be an object of the software module. Object-oriented programming utilizes units of software called “objects,” which encapsulate both data and functionality. Objects according to object-oriented programming represent software entities comprising data structures and operations on the data. This structure enables objects to model any real-world entity in terms of its characteristics represented by state elements, and its behavior represented by its functions. In this way, objects can model real things and abstract concepts like mathematical functions or geometrical computations. The method steps, the electronic content, and the persistent environment, for example, may be defined as objects, reflecting the data and processing of the electronic content. The rendering engine may be provided by the game engine as well as a graphics engine or at least parts therefore can be implemented using object-oriented programming techniques.

As used throughout this description, the terms “component,” “interface,” and “system” are intended to refer to a computer-related entity, either having hardware, firmware, a combination of hardware and software or executed software. A component can be, but is not limited to, a computer, a process running on a processor, a processor, an object, an executable, a thread, and/or a program. By way of illustration, both an application running on a processing device and a processing device can be a component.

While some embodiments have been described in detail, it is to be understood that the aspects of the disclosure can take many forms. In particular, the claimed subject matter may be practiced or implemented differently from the examples described and the described features and characteristics may be practiced or implemented in any combination. The embodiments shown herein are intended to illustrate rather than to limit the invention as defined by the claims.

The embodiments of the invention in which an exclusive property or privilege is claimed are defined as follows:

1. A device for electronic content, comprising:
a memory configured to store data associated with electronic content, the electronic content including static content, interactive content, and a state of the interactive content;
a display configured to display at least a part of the electronic content;
a network interface configured to send, via a network, the state of the interactive content and to receive an update related to the interactive content; and
a processor configured to update the state of the interactive content in response to the received update and to display on the display at least a part of the electronic content according to the updated state of the interactive content,
wherein the received update reflects a persistent environment accessible via the network, wherein the persistent environment is responsive to the sent state of the interactive content and a plurality of other states from other devices.

2. The device according to claim 1, wherein the persistent environment is hosted on a server linking a plurality of devices for electronic content.

3. The device according to claim 1, further comprising an input controller configured to detect an input of the user, wherein, responsive to detected input, the processor is configured to update the state of the interactive content based on the detected input, and to send, via the network interface, one of the updated state, the detected input, or a current state of the interactive content.

4. The device according to claim 1, wherein the displayed part of the electronic content includes at least a part of the static content in combination with at least one or more parts of the interactive content according to a current state of the interactive content.

5. The device according to claim 4, wherein the interactive content and the state are dynamically updated via the network based on the persistent environment.

6. The device according to claim 1, wherein the interactive content includes interactive elements enabling an interactive experience of the static content.

7. The device according to claim 1, wherein the interactive content includes embedded elements enabling a shared experience of the static content based on the persistent environment.

8. The device according to claim 1, wherein the processor is further configured to execute at least a part of the interactive content.

9. The device according to claim 8, wherein the executed part of the interactive content is determined based on at least the displayed electronic content and the state of the interactive content.

10. The device according to claim 1, wherein the device is an electronic book reader device and the electronic content is an electronic book.

11. The device according to claim 10, wherein the static content includes one or more parts of the electronic book and the interactive content includes interactive elements and embedded elements modifying the one or more parts of the electronic book based on the persistent environment.

12. The device according to claim 1, wherein the persistent environment reflects a persistent world of a massively multiplayer online game.

13. The device according to claim 1, wherein the received update includes media rendered by a game engine hosted on the network.

14. A network system, comprising:
a plurality of reader devices for displaying electronic content; and
one or more server devices maintaining a persistent environment, the persistent environment representing one or more electronic contents, each including static content, interactive content, and one or more states of the interactive content,
wherein the one or more server devices are configured to:
receive from a reader device, via the network, a reader state of an interactive content of an electronic content;
modify at least one of the states of the interactive content responsive to the reader state; and
send an update related to the interactive content based on the modified state of the interactive content,
wherein the persistent environment is responsive to reader states received from the plurality of reader devices.

15. The network system according to claim 14, wherein the one or more server devices are further configured to associate a reader device with one or more of the electronic contents.

16. The network system according to claim 14, wherein the one or more server devices are further configured to associate groups of reader devices associated with an electronic content with one of the one or more states of the interactive content of the electronic content.

17. The network system according to claim 14, wherein the one or more server devices are further configured to evaluate the reader states received within a predetermined period of time from a group of reader devices associated with a particular state of a particular electronic content and to update the particular state of the particular electronic content based on the evaluated reader states.

18. The network system according to claim 14, further comprising a database engine maintaining data on the plurality of reader devices and the persistent environment.

19. The network system according to claim 14, wherein the one or more server devices host a game engine configured to execute one or more game applications, each game application being associated with at least a respective one of the electronic contents, and to render output of the one or more game applications to be sent to the reader devices as the update related to the interactive content of the respective electronic content.

20. A method for controlling a device for displaying electronic content, the device comprising a display for displaying electronic content, the electronic content including static content, interactive content, and a state of the interactive content, the method comprising:
displaying to a user, via the display, at least a part of the electronic content;
sending, via a network, a state of the interactive content indicative of an interaction with the displayed electronic content;
receiving, via the network, an update related to the interactive content;
modifying the state of the interactive content in response to the received update; and
displaying to the user, via the display, at least a part of the electronic content based on the updated state of the interactive content,
wherein the received update reflects a persistent environment accessible via the network, and wherein the persistent environment is responsive to the sent state of the interactive content and a plurality of other states from other devices for displaying electronic content.
